(19) United States
(12) Patent Application Publication
(10) Pub. No.: US 2022/0275299 A1
(43) Pub. Date: Sep. 1, 2022

(54) AN IMPROVED AMMONIA BASED FUEL FOR ENGINES

(71) Applicant: COMMONWEALTH SCIENTIFIC AND INDUSTRIAL RESEARCH ORGANISATION, Acton, Australian Capital Territory (AU)

(72) Inventor: Louis James WIBBERLEY, Garden Suburb, New South Wales (AU)

(73) Assignee: COMMONWEALTH SCIENTIFIC AND INDUSTRIAL RESEARCH ORGANISATION, Acton, Australian Capital Territory (AU)

(21) Appl. No.: 17/636,790

(22) PCT Filed: Aug. 21, 2020
(86) PCT No.: PCT/AU2020/050875

§ 371 Date: Feb. 18, 2022

(30) Foreign Application Priority Data
Aug. 21, 2019 (AU) 2019903045

(51) Int. Cl. C10L 8/00; F02M 25/025; F02B 9/04

(52) U.S. Cl. CPC C10L 8/00; F02M 25/025; F02B 9/04; C10L 2200/0259; C10L 2200/0469; C10L 2200/0254; C10L 2270/026; C10L 2290/24; C10L 2200/0295; C10L 2290/46

(57) ABSTRACT

A fuel formulation comprising a sugar and ammonia solution, wherein the sugar and ammonia are present in a combined amount of greater than 70 percent by weight of the fuel formulation, and wherein the sugar comprises fructose, glucose, sucrose or a combination thereof.

### PRIORITY CROSS-REFERENCE

The present application claim priority from Australian Provisional Patent Application No. 2019903045 filed 21 August 2019, the contents of which should be understood to be incorporated into this specification by this reference.

### TECHNICAL FIELD

The present invention generally relates to the use of ammonia-based fuels in reciprocating engines, gas turbines, and heating devices. The invention is particularly applicable to compression ignition engines and Otto type engines and it will be convenient to hereinafter disclose the invention in relation to that exemplary application. However, it is to be appreciated that the invention is not limited to that application and could be used in a variety of combustion application.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

There is currently a world-wide interest in fuelling reciprocating engines, particularly compression ignition (diesel) engines, with ammonia-based fuel produced from renewable energy. Ammonia (also termed anhydrous ammonia to distinguish it from ammonia water solutions with relatively low ammonia concentrations) has the potential to provide a cost effective, environmentally friendly, zero carbon fuel.

Some of the advantages of liquid ammonia as an energy carrier/fuel include:
Can be produced from renewable energy—especially wind, solar, and hydro—using a range of mature technologies.
Produces no CO₂ or SOx emissions on combustion and can be implemented to produce very low NOx emissions, with no carbonaceous or ash particulates.
Stable, long term energy storage (higher energy density and lower cost than hydrogen) and enables rapid refilling of fuel tanks.
The ability to be used in specially adapted conventional engines (diesel engines and spark-ignited reciprocating engines, gas turbines).
Commercial storage and delivery systems for ammonia are both mature technology with infrastructure similar to LPG.

However, ammonia has several disadvantages which have hampered its use in modern engines—in particular its poor ignition properties and slow combustion.

To overcome these disadvantages, several schemes have been previously proposed including:

Co-firing with diesel, methanol, methane, or hydrogen introduced to the engine using separate fuel handling systems. One example is diesel fuel being injected using conventional diesel engine fuel injection system to provide the ignition source for ammonia fuel injected into the air stream entering the engine. Reiter and Kong (“Demonstration of Compression-Ignition Engine Combustion Using Ammonia in Reducing Greenhouse Gas Emissions”, Energy & Fuels, 22, 2963-2971, (2008)) teach one form of this system, where ammonia was continuously injected into the intake manifold (fumigation) of a 4-litre diesel engine, with diesel fuel or biodiesel directly injected into the cylinder to ignite the ammonia-air mixture. Reiter and Kong showed that a reasonable fuel economy could be obtained when ammonia is adjusted to provide 40 to 80% of the total energy. In another example, Ryu, K et al, (“Performance characteristics of compression-ignition engine using high concentration of ammonia mixed with dimethyl ether”, Applied Energy, 113, 488-499 (2014)) showed that direct injection of ammonia and dimethyl ether (DME) mixtures could be successfully used as a fuel. DME was chosen due to the similarity in vapour pressure to ammonia, the high cetane number (which aids ignition) of DME, and the miscibility of the two fuels. It was found that engine performance decreased as ammonia concentration in the fuel mixture increased. In addition, significant cycle-to-cycle variations were observed when higher ammonia ratios greater than 50% NH3 was used, especially at lower loads. However, as the engine load increased, cycle-to-cycle variations decrease. With an increase in ammonia concentration, both engine speed and engine power were reduced compared to the 100% DME cases.

Adding ammonium nitrate to liquid ammonia: One example is taught in U.S. Pat. No. 2,393,594 (Du Pont, 1946) in which a solution of ammonium nitrate in liquid ammonia was used as a fuel for internal combustion engines. Various blends of combustible and oxidising agent reported using a diesel engine with 19 to 90 wt % ammonium nitrate in ammonia, 80 wt % ammonium nitrate-ammonia mixture blended with methyl alcohol in various proportions, a 50:50 blend of dimethyl formamide and ammonium nitrate saturated ammonia, together with a small amount of ethyl nitrate, and ammonium nitrate dissolved in dimethyl formamide in a 30:70 ratio. United States patent application 2011/0197500A1 by Ganley and Bowery provides a more recent example of the use ammonium nitrate-ammonia solutions, which claims lower storage pressure and improved ignition and combustion can be produced—but without any specification of the claimed range of ammonium nitrate:ammonia ratios.

Based on the above, there is therefore still some scope to improve ammonia-based fuels. It would therefore be desirable to provide an alternate or improved ammonia-based fuel and method that can be used in reciprocating engines, gas turbines, and heating devices, and in particular for compression ignition engines.

### SUMMARY OF THE INVENTION

A first aspect of the present invention provides a fuel formulation comprising a solution of a sugar component and ammonia, wherein the sugar component and ammonia are present in a combined amount of greater than 70 percent by weight of the fuel formulation, and wherein the sugar component comprises at least one of fructose, glucose, or sucrose.

The inventor has discovered that a solution of sugar mixed into, preferably dissolved within ammonia results in an improved ammonia-based fuel that can be used in a variety of applications including in reciprocating engines, gas turbines, and heating devices. One exemplary use is as a fuel in a compression ignition engine—for example a diesel engine—or an Otto type engine. The first aspect provides a fuel formulation which comprises a solution of sugar and ammonia which comprises at least 70% of the fuel composition. This new fuel composition is a solution, with the sugar content (solute) being dissolved within the ammonia (solvent).

The term sugar in the present description refers to simple carbohydrates, such as saccharides, more particular monosaccharides and disaccharides. The sugar component of the fuel formulation is more specifically based on regular sugar which essentially consists of sucrose, a disaccharide composed of glucose and fructose joined by a glycosidic bond. Sucrose can be hydrolysed to the component monosaccharides. Accordingly, the sugar content of the fuel formulation of the present invention can comprise one or more of glucose, sucrose, or fructose; or in some cases, a combination of one or more of those components; and in some cases, a combination of all of those components. The sugar content predominantly/substantially comprises these saccharides. However, depending on the form of the sugar, it may also contain various amounts of water, and also small amounts of protein and trace elements (for example, molasses).

As noted above, the fuel composition of this first aspect comprises a solution of the sugar component dissolved in ammonia. In some embodiments, the present invention provides a fuel formulation comprising sugar component dissolved in ammonia, wherein the sugar and ammonia are present in a combined amount of greater than 70 percent by weight of the fuel formulation, and wherein the sugar component comprises at least one of fructose, glucose, or sucrose.

In some embodiments, the ratio of sugar to ammonia in this solution is in the range 0.01:1 to 2:1 w/w, preferably 0.1:1 to 1.5:1 w/w, more preferably 0.1:1 to 1:1, and yet more preferably 0.2:1 to 0.8:1 w/w. In some embodiments, the ratio of sugar to ammonia is 0.02:1 to 0.9:1 w/w, preferably 0.05:1 to 0.8:1 w/w, more preferably 0.01:1 to 0.75:1 w/w. The preferred ratio will depend on a number of factors including the application, the type and amounts of any other additives in the solution, desired economics of the fuel system and combustion arrangement (engine), the engine type, and the engine operating conditions. Engine operating conditions include rpm, loading, temperature and the like.

In particular embodiments, the sugar content added to the fuel composition comprises an aqueous sugar solution comprising from 50 to 80% w/w solution, preferably from 60 to 75% w/w sugar solution. This sugar solution can in some embodiments be formed by dissolving the sugar (for example domestic grade raw sugar) in hot water. However, various other methods could also be used. The sugar solution can be dosed into the ammonia stream to produce the fuel composition of the required composition. Dosing can be achieved at any suitable temperature. In some embodiments, dosing is at room temperature, for example at approximately 25 to 30° C. The ratio of sugar to ammonia in this 2 to 40% w/w, preferably 5 to 30% w/w depending on the engine operating conditions. For example, for acceptable engine performance at 400 rpm, 5 to 10% w/w of sugar solution can be used. For 700 rpm, 15 to 20% w/w of sugar solution can be used for acceptable engine performance.

The ammonia component of the fuel formulation of the present invention preferably comprises anhydrous ammonia. The ammonia fuel typically comprises a liquid ammonia. This ammonia content of the fuel formulation is generally not an ammonia water solution having a relatively low ammonia concentration. A high/substantive content of ammonia in the ammonia fuel is preferred.

The new fuel formulation may also contain a smaller amount (less than 30 wt %) of other components. In embodiments, the fuel formulation may further comprise one or more additives selected from at least one of: water, ammonium nitrate, an alcohol, a lubricant, a picrate, a permanganate, or a peroxide. Examples of the one or more additives include water, ammonium nitrate and other ignition promoters such as potassium permanganate, iron picrate, peroxides such as hydrogen peroxide, fuels such as ethanol, methanol, or a lubricant such as a paraffinic oil to reduce the wear of the fuel injection system and engine

The alcohol additive may comprise at least one of methanol, ethanol, propanol, and butanol. In preferred embodiments, the alcohol comprises ethanol or methanol.

The lubricant additive can comprise any suitable fuel compatible to reduce the wear of the fuel injection system and engine. In some embodiments, the lubricant comprises a paraffinic oil. In some embodiments, the lubricant comprises at least one of Friction modifiers such as molybdenum disulfide, antiwear additives such as zinc dialkyldithiophosphate or zinc dithiophosphates, nanoparticles such as inorganic fullerene-like tungsten disulfide (IF-WS2) nanoparticles.

The fuel may include other ignition promoters such as potassium permanganate, iron picrate, and/or a peroxide. In some embodiments, one or more picrate is used as a fuel additive. In many embodiments, the picrate comprises Ferrous Picrate (FPC). FPC is added to as a combustion supporting additive and/or to increase fuel efficiency. In some embodiments, one or more permanganate is used as a fuel additive. In many embodiments, the permanganate comprises potassium permanganate. The permanganate acts as a combustion supporting additive. In some embodiments, one or more peroxides is used as a fuel additive. In many embodiments, the peroxide comprises hydrogen peroxide.

The fuel formulation preferably comprises an engine fuel, preferably a reciprocating engine fuel. In embodiments, the fuel formulation comprises a compression ignition engine fuel

The present invention is applicable for using such ammonia fuels in a reciprocating engine and more preferably an internal combustion engine. The invention can be used in a variety of internal combustion engines, including compression ignition engines or spark, plasma or laser ignition engines. In these embodiments, the head location will preferably comprise a cylinder head.

Aspects of the present invention are also applicable to opposed piston and free piston engines. In these embodiments, each cylinder preferably includes two pistons that move reciprocally within that cylinder in opposite directions, forming a compression end at the head location and combustion chamber therebetween, at least one inlet valve or port (typically located in a cylinder side wall) through which combustion gases are fed into the combustion chamber and at least one exhaust valve or port (typically located in a cylinder side wall) through which spent combustion gases egress the combustion chamber, the pistons moving the cylinder in a cycle between top dead center where the piston is located closest to the opposite piston and bottom dead center where the piston is located furthest from the opposite piston, and including at least one fuel injector located in the cylinder wall.

In opposed piston and free piston engines embodiments, the head of the pistons (in most cases the rings thereon) act to cover and uncover ports in the cylinder walls which together form an inlet and exhaust valve. Thus, each of the inlet valve/port and exhaust valve/port is uncovered by a respective piston during the respective piston stroke. Here, one piston has an inner face that uncovers at least one inlet valve port closest to that piston's outermost travel through which combustion gases are fed into the combustion chamber and the other opposite piston has an inner face that uncovers at least one exhaust valve towards that piston's outermost travel through which spent combustion gases egress the combustion chamber.

It should be appreciated that present invention is applicable to opposed piston engines and free piston engines without a crank. These engines may use a linear generator to take-off power and to drive compression. In some forms, the opposed piston engines may have a scavenge belt at one end and exhaust belt at the other end.

A compression ignition engine is a type of internal combustion engine in which ignition of fuel injected into a combustion chamber of an engine cylinder is caused by the elevated temperature of the air in the cylinder due to the mechanical compression. The expansion of the high-temperature and high-pressure gases produced by combustion applies direct force to drive motion of a piston within a cylinder, which in turn drives motion of a driven section of the engine. Compression ignition engines include engines such as diesel engines. However, it should be appreciated that the compression ignition engine of the present invention is not limited to diesel type engine configurations.

It should be appreciated that the cylinder location defines a top or upper limit or point of the cylinder which the piston moves towards in its reciprocating motion within the cylinder. In many cylinder configurations the head location is defined by the cylinder head. However, in those cylinder configurations that do not include a cylinder head, for example opposed piston and free piston engines, the head location comprises the point in the cylinder marking the maximum top limit of that movement at the cylinder in the compression and exhaust stroke (as described below).

It should also be appreciated that top dead centre of a piston within its respective cylinder is when the piston is at the closest position to the cylinder head/head location within the cylinder during its reciprocating movement and that bottom dead center at the furthest spaced apart position from the cylinder head/head location during its reciprocating movement. In a multi-cylinder engine, pistons may reach top dead centre simultaneously or at different times depending on the engine configuration. In a reciprocating engine, top dead centre of piston number one is the point from which ignition system measurements are made and the firing order is determined. For example, ignition timing is normally specified as degrees of crankshaft rotation before top dead centre (BTDC).

In most reciprocating engines, the piston moves in a particular stroke cycle (a reciprocating movement/reciprocating cycle) within the cylinder in a series of repeated cycle of strokes as follows:

an inlet stroke in which the exhaust valve is closed, the inlet valve is open, and the piston is initially located top dead center proximate but spaced away from the head location and moves away from the head location to draw a fuel/air mixture (or air alone, in the case of a direct injection engine) into the piston;

a compression stroke in which the exhaust valve and the inlet valve are closed, and the piston is initially located bottom dead center and moves toward the head location to compress the air/fuel mixture (or air alone until fuel is injected into the combustion chamber, in the case of a direct injection engine) in the combustion chamber. Towards the end of this phase, the fuel/air mixture is ignited—for example, by a spark plug or other ignition means for petrol engines, or by self-ignition for compression ignition engines such as diesel engines;

a combustion stroke in which the exhaust valve and inlet valve are closed, and the piston is initially located top dead center and expansion of the ignited fuel mixture is forced away from the head location by in the combustion chamber between the head location and piston head (compression end of the piston); and an exhaust stroke, where the exhaust valve is open and the inlet valve is closed, and the piston is initially located bottom dead center and moves towards the head location to expel the spent combustion gases through the exhaust valve. This stroke cycle is repeated.

It should be appreciated that fuel is injected into the combustion chamber of direct injection engines during the compression stroke to enable the combustion stroke to occur. It should also be appreciated that the combustion gases comprise air, or air with O₂ and/or with other combustibles.

In the context of this repeated cycle of strokes, the ammonia fuel is preferably injected into the combustion chamber of each cylinder during compression stroke of the engine cycle. In this context, the ammonia fuel is combusted in that combustion stroke by compression (compression ignition engines) or by a spark, plasma, laser combustion initiator.

Whilst not discussed in the context of the piston movement above, it should be understood the cylinder and piston of the present invention can operate and incorporates the features of a conventional reciprocating engine, and more particularly an internal combustion engine. For example, in many internal combustion engines the base of each piston is preferably connected to a connecting rod, which is in turn connected to a crankshaft. The reciprocating movement of each piston drives rotation of that crankshaft. Thus, the connecting rod converts the rotary motion of the crankshaft into the back-and-forth motion of the piston in its cylinder. The cylinder has the cylinder head at one end and is open at the other end to allow the connecting rod to do its work. The piston is effectively sealed to the respective cylinder by two or more piston rings. However, again it should be appreciated that other configurations are possible. For example, instead of a crank an engine may use a linear generator to take-off power and to drive compression.

In the context of the above, it should also be appreciated that movement of the piston in degrees referred throughout this specification is in crank degrees, i.e. the relative rotation of the crank corresponding to the driven reciprocal movement of the piston. Each full cycle of reciprocating movement of the piston between top dead center corresponds to 360 degrees movement of the crank shaft.

The features of this piston arrangement and associated engine configuration are well known in the art. It is to be understood that operation and configuration of such an internal combustion engine would be well understood by a person skilled in the art, and the features of the method of the method for injection of liquid or gaseous ammonia fuel into a reciprocating engine according to the present invention could be readily adopted by the person skilled in the art in a conventional reciprocating engine following the teaching of the present specification.

A second aspect of the present invention provides a method of operating a compression ignition engine or an Otto type engine using a fuel formulation according to the first aspect of the present invention, comprising injecting the fuel formulation into the engine for combustion. The fuel formulation is preferably injected into a combustion chamber of the engine as an atomised jet. The fuel is injected under atomisation conditions in which the fuel is sufficiently atomised to prevent deposition of sugar residue on heated engine surfaces. The atomisation conditions are preferably high-intensity atomisation conditions. For example, the fuel formulation may be injected at a pressure of at least 25 bar. In some embodiments, the droplets of the atomised fuel jet are injected at a selected pressure that prevents deposition of sugar residue on heated engine surfaces.

In exemplary embodiments, the fuel formulation is port injected into the engine. Port injection sprays fuel into the intake ports, where it mixes with the incoming air. When the intake valve opens, the fuel mixture is pulled into the engine cylinder. With direct injection, the injectors are in the cylinder head and spray fuel directly into the combustion chamber, mixing with the air charge.

A third aspect of the present invention provides a method of operating a compression ignition engine according the second aspect of the present invention, in which the engine includes at least two cylinders, each cylinder including a piston that moves reciprocally within that cylinder, each cylinder having a head location at one end located opposite to a compression end of the piston and defining a combustion chamber therebetween, the cylinder including at least one inlet valve through which combustion gases are fed into the combustion chamber and at least one exhaust valve through which spent combustion gases egress the combustion chamber, the piston moving the cylinder in a cycle between top dead center where the piston is located closest to the head location and bottom dead center where the piston is located furthest from the head location, and including at least one fuel injector,

and wherein the method comprises:

injecting the ammonia fuel into the combustion chamber of each cylinder using the at least one fuel injector as at least one fuel jet with a timing of:

after the at least one exhaust valve of the respective cylinder is substantially closed;

after the least one inlet valve is closed; and

before the respective piston moves to at most 35 degrees prior to top dead centre.

The ammonia fuel is preferably injected into the combustion chamber of each cylinder during compression stroke of the engine cycle. In some embodiments, the ammonia fuel is injected into the combustion chamber of each cylinder with a timing of:

after the at least one exhaust valve is substantially closed;

after the least one inlet valve is closed; and and

before the piston moves to 35 degrees prior to top dead centre.

In some embodiments, the method the third aspect of the present invention further comprises:

flowing the fuel formulation from a fuel tank for injection into the engine, and

introducing at least one additive into the fuel formulation between the fuel tank and the injection of the ammonia fuel into the combustion chamber.

The at least one additive is preferably introduced into the fuel formulation using an additive dosing system configured to adaptively dose the amount of the additive depending on an operating condition of the engine. Advantageously, this may reduce or avoid the need for bulk pre-blending of fuel additives while allowing the engine to operate over a wider range of operating conditions.

The compression injection engine preferably comprises a diesel type engine. While the preferred application for the fuel in the present invention is compression-ignition or diesel engines where the start of fuel injection is late in the compression stroke just prior to the required start of ignition, the fuel could also be used advantageously in Otto (spark, plasma or other ignitors) and homogeneous charge compression ignition (HCCI) reciprocating engines, and also in gas turbines and other continuous combustion devices such as furnaces and boilers.

The present invention can relate to direct injection engines where the fuel injector is located at or in the head location in a cylinder head of that cylinder. However, it should be appreciated that other injector configurations are possible, for example side injector configurations.

A variety of injector configurations are possible in the head location in a cylinder head of that cylinder. For example, the fuel injector may comprise at least one of: a single fuel injector located in the center of the cylinder head; or at least two fuel injectors spaced apart across the diameter of the cylinder head. In some embodiments, the fuel injector comprises at least one semi-axial nozzle fuel injector located near the centre of the cylinder with near fuel jets directed downwards. In other embodiments, the fuel injector comprises at least one semi-axial discharge nozzle liquid ammonia injector(s) located near the cylinder wall with near semi-axial fuel jets directed downwards towards the piston.

### BRIEF DESCRIPTION OF THE DRAWINGS

The present invention will now be described with reference to the figures of the accompanying drawings, which illustrate particular preferred embodiments of the present invention, wherein:

FIG. 1 is a schematic cross-sectional view of one cylinder of a trunk uniflow 2-stroke engine with an injector providing an example of an engine that operates using a fuel formulation according to an embodiment of the present invention.

FIG. 2 shows a modified stock jerk pump used to feed a fuel composition according to an embodiment of the present invention into a diesel engine for an experimental run.

### DETAILED DESCRIPTION

The present invention comprises an improved ammonia-based fuel for reciprocating engines, gas turbines, and other combustion devices.

The inventor has discovered that an improved ammonia-based fuel can be formed by mixing a sugar content within ammonia. The present invention provides a fuel formulation comprising a solution of sugar and ammonia, wherein the sugar and ammonia are present in a combined amount of greater than 70 percent by weight of the fuel formulation. This new fuel formulation/composition is a solution, with the sugar content (solute) being dissolved within the ammonia (solvent). The sugar content may be dissolved within ammonia at ambient temperatures at up to around 60 wt %, although the actual amount depends on the amounts of the above-mentioned additional additives in the ammonia. It should be appreciated that the sugar content can be mixed directly into the ammonia in pure form, or in many cases, mixed as an aqueous solution, for example a 60 to 80% w/w sugar solution.

As explained previously, this new fuel formulation may also contain a smaller amount (less than 30 wt %) of other components such as one or more of water, ammonium nitrate and other ignition promoters such as potassium permanganate, iron picrate, peroxides and fuels such as ethanol, methanol, or a lubricant (for example a paraffinic oil) to reduce the wear of the fuel injection system and engine.

The present invention improves on previous ammonia-based fuel mixtures through the addition of a sugar content. Whilst not wishing to be limited to any one theory, it is believed that the sugar content both oxygenates the fuel and forms finely divided combustible aerosols and vapours during rapid heating within the engine, which improves ignition, flame speed, overall combustibility, engine thermal efficiency and reduces nitrogen oxide emissions.

Although the phenomena involved are complex and again not wishing to be limited to any one theory, the inventor proposes a combustion mechanism using the new fuel formulation can be summarised as follows:
1) the injected fuel is atomised by a combination of flashing and turbulence (in the case of pressure atomisation) to produce a 3-phase mixture of volatile ammonia, liquid fuel droplets, and finely distributed sugar-derived solids/aerosol;

2) further heating of the mixture causes the “sugar” aerosol to decompose/melt and spontaneously combust;
3) the fine dispersion and high flame speed of the non-ammonia fuel components thereby increase the effective flame speed of the ammonia mixture.

Overall, this enhanced combustibility allows ammonia to be used in higher speed engines and gas turbines where the time for combustion is shorter than that required for ammonia only combustion.

The blending of sugar also reduces the heat of vaporisation of the fuel, which further assists combustibility by increasing the temperature of the mixture at the time of initiation of combustion.

The presence of sugar also reduces the vapor pressure of ammonia, allowing it to be stored in tanks at pressures closer to atmospheric pressure which reduces the cost of storage equipment and reduces the environmental and safety implications of leaks.

The preferred application for the fuel in the present invention is compression-ignition or diesel engines where the start of fuel injection is late in the compression stroke just prior to the required start of ignition. However, it should be appreciated that the fuel could also be used advantageously in Otto (spark, plasma or other ignitors) and homogeneous charge compression ignition (HCCI) reciprocating engines, and also in gas turbines and other continuous combustion devices such as furnaces and boilers.

As detailed above, the invention provides a method of operating a compression ignition engine (preferably a diesel engine) or Otto engine, comprising injecting the fuel formulation of the present invention disclosed herein into the engine for combustion. The fuel formulation may be injected under high-intensity atomisation conditions such that the fuel is sufficiently atomised to prevent deposition of sugar residue on heated engine surfaces. In some embodiments, the fuel formulation is injected at a pressure of at least 25 bar.

It has been discovered that the negative effects of the lower vapour pressure of the sugar-ammonia mixtures can be readily overcome by correct choice of atomiser and fuel pressure. Normally ammonia is injected at relatively low pressures due to the high vapour pressure of the fuel, for example, port injection of liquid ammonia is handled in a similar fashion to liquified petroleum gas or DME (dimethyl ether) occurs around 20 bar which is sufficient to ensure liquid at the injector nozzle. For these fuels this results in rapid flashing of the fuel jet(s) to give predominantly a gaseous fuel mixture. Port injection of the sugar-ammonia based fuel of the present invention requires more intense atomisation to produce the advantageous sugar aerosol, to ensure efficient combustion and to reduce the formation of sugar-based decomposition residues on the back of the inlet valve(s). This can be achieved, for example, by using higher injection pressure and finer nozzles than are normally required for port injection to ensure fine dispersal of the sugar-derived components of the fuel. Overall, the choice of fuel injection method and the intensity of atomisation should be matched to the sugar-ammonia blend used and engine type. For example, port injection of an Otto engine will likely require lower sugar:ammonia ratio and high injection pressure than for ammonia only. Direct injection will require optimisation of the injectors nozzle/delivery rate to account for the higher viscosity of higher sugar:ammonia ratios.

Where the fuel is used in a compression ignition engine, the method of operating that compression ignition engine preferably comprises injecting the fuel formulation of the present invention via fuel jets into the combustion chamber of a cylinder of the engine after substantial closure of the exhaust valve(s) of that cylinder, after the inlet valve/ports of that cylinder are closed, and before 35° before the piston in that cylinder reaches top dead centre. The fuel formulation is injected after closure of the exhaust valves and inlet valve/ports to limit or prevent loss of unburnt ammonia to the exhaust, and before 35° before top dead centre to allow fuel vaporisation and preparation for ignition.

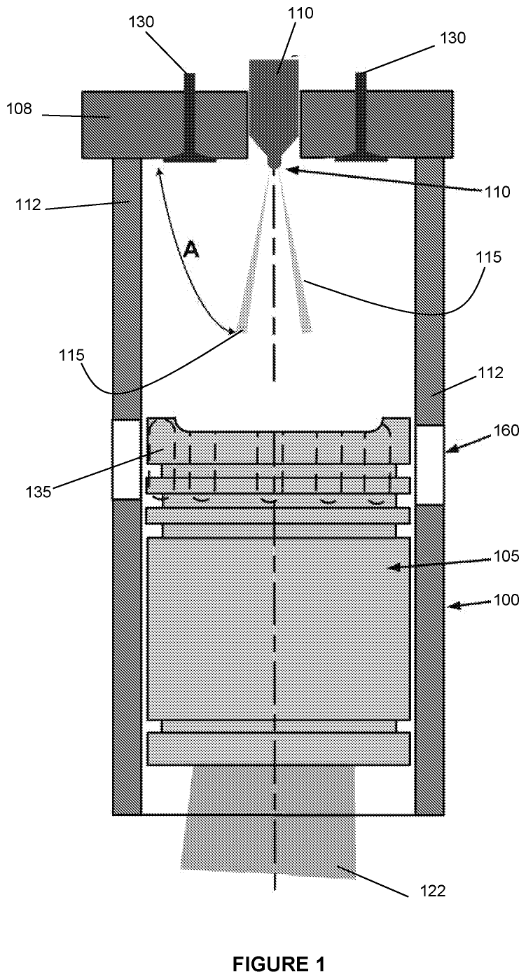

FIG. 1 shows a cross-sectional view of one cylinder 100 and piston 105 combination for a trunk piston uniflow 2-stroke engine that can be fuelled using the fuel formulation of the present invention. The cylinder 100 includes a cylinder head 108 having a radial nozzle fuel injector 110 located near the centre of the cylinder 100 and cylinder head 108 which directs fuel jets 115 outwardly therefrom towards the cylinder walls 112. The cylinder head 108 includes exhaust outlet valves 130. As illustrated, the piston 105 includes a connecting rod 122 which is connected at the other end to a crankshaft (not shown). The cylinder 100 also includes a scavenger belt 160 which include inlet ports 115 that are uncovered by the piston 105 towards the bottom of the piston stroke (when the piston 105 is close to bottom dead center). In this schematic, the fuel is injected through injector 110 such that the centreline Y of fuel jets 115 form an angle A relative to baseline X. Suitable angles A are of −30° and +5° or −90° and −35°. The injectors 110 would typically include 1 to 16 orifices in the nozzle. Ammonia injection is timed to occur after the exhaust valve(s) 130 close and before 35 crank degrees of top dead centre. The exhaust valves 130 are closed and after the inlet valve/ports 115 are closed during ammonia injection so to limit/control ammonia slip to the exhaust.

As a further embodiment of the invention, the base sugar-ammonia fuel could be adaptively doped with trace additives between the fuel tank and the engines high-pressure injection system, including with additives such as a lubricant, or other liquids to promote ignition and combustion, and to reduce emissions. One such suitable device is a small high-pressure additive dosing system controlled by the engine's CPU. In this embodiment, the additive rate would be adjusted according to engine operating conditions to optimise the performance of the sugar-ammonia fuel for the particular engine and operating conditions (for example coolant temperature, engine load), thus avoid the requirement for bulk fuel treatment.

Therefore, in some embodiments, the fuel formulation can be flowed from a fuel tank for injection into the engine, and one or more additives are introduced into the fuel formulation between the fuel tank and fuel injection of the fuel into the combustion chamber. The one or more additives may be introduced into the fuel formulation using an additive dosing system configured to adaptively dose the amount of the additive depending on an operating condition of the engine. Advantageously, this may reduce or avoid the need for bulk pre-blending of fuel additives while allowing the engine to operate over a wider range of operating conditions.

The present invention has a sound economic and environmental basis. Ammonia has a heat of combustion of 18.8 GJ/t lower heating value, at a cost of around A$1,000/t from renewable electricity, giving a specific energy cost of A$44/GJ. In comparison, sugar has a heat of combustion of around 16 GJ/t, at a cost of around A$400/t or A$24.0/GJ. As Australia exports around 4 Mtpa of sugar, and has excess production capacity, there is considerable scope for exploiting sugar as sugar-ammonia fuel blends. On a life cycle basis, the energy efficiency of using sugar as an ammonia blended fuel is substantially higher than converting it to ethanol for similar applications.

EXAMPLE

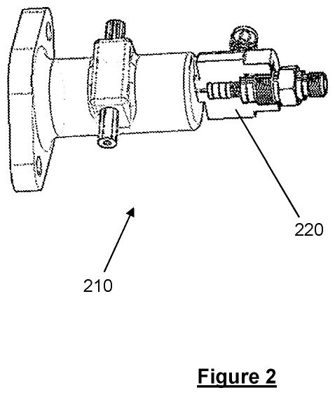

A four litre single cylinder diesel laboratory engine (adapted from a single cylinder engine, Satyjeet SL22). The ammonia fuel was injected into the engine using a modified stock jerk pump 10 (shown in FIG. 2) and a standard fuel injection pump (not illustrated). The jerk pump 10 was modified by removing the delivery valve on top of the pump and replacing this with a shuttle pump 20 (i.e. a media separator, shown sectioned in FIG. 2) to enable the standard injection pump to pump ammonia using the diesel fuel pulses from the standard injection pump. Anhydrous ammonia was supplied from the ammonia bottle to the shuttle pump via a booster pump (a small air actuated pump) at 25 bar to avoid vapour formation in the low pressure supply line to the engine. Immediately after the booster pump, a concentrated sugar solution was injected into the ammonia from a laboratory high pressure syringe pump. The rate of dosing of sugar solution was adjusted to match the average flowrate of ammonia as measured by a Coriolis flowmeter. To assist mixing with this setup, a 200 mm length of 20 mm Swagelok tubing (filled with Swagelok ferrules to act as packing) was fitted to the line downstream of the dosing point and upstream of the shuttle injection pump. The sugar solution was 75% by weight domestic grade raw sugar in hot water. The sugar solution was dosed into the ammonia stream at approximately 25 to 30° C. At this temperature the sugar solution showed no apparent recrystallisation.

A control fuel comprising 100% anhydrous ammonia was also used as a fuel as a comparison.

Engine testing found that the inventive sugar-ammonia solution fuel gave excellent ignition and combustion at up to 700 rpm.

For this setup 5 to 10% sugar solution was required to provide acceptable engine performance at 400 rpm, using the standard fuel injection timing as for diesel fuel. 15% sugar (0.15:1 sugar:ammonia, or 20% by weight of sugar solution) was required to provide acceptable engine performance at 700 rpm giving an exhaust temperature of 480° C., using the standard fuel injection timing as for diesel fuel.

The effect of sugar in improving both ignition and combustion rate was evident by the faster heat release rate in the engine after the start of injection, and particularly by the exhaust gas temperature which decreased from over 650° C. without sugar, to 420 to 480° C. with 5 to 10% by weight sugar solution, respectively—all at a constant 15 kW engine output at 400 rpm.

The comparative runs using ammonia as fuel alone found that that fuel combusted only slightly in the engine giving very high exhaust temperatures and low power.

While this simple setup has served to demonstrate the method, in practice several improvements in the apparatus would be used to optimise the benefits of the invention. These include the use of a continuous flow dosing pump such as a speed controlled positive displacement multi-cylinder oil-backed diaphragm pump for the sugar solution, and an electronically controlled injection system which can vary the injection timing to account for engine temperature, load, and sugar dosing rate. These effects will vary according to the engine used. The ammonia-sugar mixer could also be improved, for example by the use of a static mixing tube comprising interrupted spiral vanes as are used for mixing various fluids.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A fuel formulation comprising a solution of a sugar component and liquid anhydrous ammonia, wherein the sugar component and liquid anhydrous ammonia are present in a combined amount of greater than 70 percent by weight of the fuel formulation, and wherein the sugar component comprises fructose, glucose, sucrose or a combination thereof.

2. A fuel formulation according to claim 1, wherein the ratio of sugar to liquid anhydrous ammonia is in the range 0.01:1 to 2:1 w/w.

3. A fuel formulation according to claim 1, wherein the ratio of sugar to liquid anhydrous ammonia is in the range 0.1:1 to 1.5:1 w/w, preferably 0.1:1 to 1:1, and yet more preferably 0.2:1 to 0.8:1 w/w.

4. A fuel formulation according to claim 1, wherein the solution comprises the sugar component dissolved in liquid anhydrous ammonia.

5. A fuel formulation according to claim 1, further comprising one or more additives selected from at least one of: water, ammonium nitrate, an alcohol, a lubricant, a picrate, a permanganate, or a peroxide.

6. A fuel formulation according to claim 5, wherein the one or more additives comprise water, ammonium nitrate, potassium permanganate, iron picrate, hydrogen peroxide, ethanol, methanol, or a paraffinic oil.

7. A compression ignition engine fuel comprising the fuel formulation according to claim 1.

8. A method of operating a compression ignition engine or an Otto type engine using a fuel formulation according to claim 1, comprising injecting the fuel formulation into the engine for combustion.

9. A method according to claim 8, wherein the fuel formulation is injected into a combustion chamber of the engine as an atomised jet.

10. A method according to claim 9, wherein the droplets of the atomised fuel jet is injected at a selected pressure that prevents deposition of sugar residue on heated engine surfaces.

11. A method according to claim 10, wherein the fuel formulation is injected at a pressure of at least 25 bar.

12. A method according to claim 8, wherein the fuel formulation is port injected into the engine.

13. A method of operating a compression ignition engine according to claim 8, in which the engine includes at least two cylinders, each cylinder including a piston that moves reciprocally within that cylinder, each cylinder having a head location at one end located opposite to a compression end of the piston and defining a combustion chamber therebetween, the cylinder including at least one inlet valve through which combustion gases are fed into the combustion chamber and at least one exhaust valve through which spent combustion gases egress the combustion chamber, the piston moving the cylinder in a cycle between top dead center where the piston is located closest to the head location and bottom dead center where the piston is located furthest from the head location, and including at least one fuel injector,
and wherein the method comprises:
injecting the ammonia fuel into the combustion chamber of each cylinder using the at least one fuel injector as at least one fuel jet with a timing of:
after the at least one exhaust valve of the respective cylinder is substantially closed;
after the least one inlet valve is closed; and
before the respective piston moves to at most 35 degrees prior to top dead centre.

14. A method of claim 13, wherein the ammonia fuel is injected into the combustion chamber of each cylinder during compression stroke of the engine cycle.

15. A method of claim 13, wherein the ammonia fuel is injected into the combustion chamber of each cylinder with a timing of:
after the at least one exhaust valve is substantially closed;
after the least one inlet valve is closed; and and
before the piston moves to 35 degrees prior to top dead centre.

16. A method according to claim 8, further comprising:
flowing the fuel formulation from a fuel tank for injection into the engine, and
introducing at least one additive into the fuel formulation between the fuel tank and the injection of the ammonia fuel into the combustion chamber.

17. A method according to claim 16, wherein the at least one additive is introduced into the fuel formulation using an additive dosing system configured to adaptively dose the amount of the additive depending on an operating condition of the engine.

18. A method according to claim 8, wherein the compression injection engine comprises a diesel type engine.

19. A method according to claim 13, wherein the compression injection engine comprises a diesel type engine.

20. A method according to claim 15, wherein the compression injection engine comprises a diesel type engine.
